(19) United States
(12) Patent Application Publication
(10) Pub. No.: US 2002/0181719 A1
(43) Pub. Date: Dec. 5, 2002

(54) Notebook with recording module

(76) Inventor: Chin-Lien Ho, Taichung City (TW)

Correspondence Address: BAKER BOTTS LLP, C/O INTELLECTUAL PROPERTY DEPARTMENT, THE WARNER, SUITE 1300, 1299 PENNSYLVANIA AVE, NW, WASHINGTON, DC, 20004-2400, US

(21) Appl. No.: 09/872,009

(22) Filed: Jun. 4, 2001

(51) Int. Cl. B42D 3/00

(52) U.S. Cl. 381/87

(57) ABSTRACT

A notebook includes a foldable cover member, a recording module, and a notepad. The cover member includes front and back cover parts connected foldably to each other. The recording module has a frame unit mounted on the cover member, a data storage unit mounted on the frame unit for storing audio information, and audio recording and playback units mounted on the frame unit and coupled to the data storage unit. The audio recording unit is operable so as to record the audio information in the data storage unit. The audio playback unit is operable so as to audibly reproduce the audio information in the data storage unit. The notepad is retained in the cover member and is disposed between the front and back cover parts.

### BACKGROUND OF THE INVENTION

1. Field of the Invention

The invention relates to a notebook, more particularly to a notebook with a recording module.

2. Description of the Related Art

Conventional notebooks generally include front and back covers, and a notepad retained therebetween. Some notebooks have covers printed with pictures of popular cartoon characters and idols, etc., and have notepads printed with nice verses, maxims, etc., so as to cater to different types of consumers. However, none of them provides an additional function to allow the user to record and playback a voice note or message at will.

### SUMMARY OF THE INVENTION

Therefore, the main object of the present invention is to provide a notebook with a recording module.

Accordingly, a notebook of the present invention includes a foldable cover member, a recording module, and a notepad. The cover member includes front and back cover parts connected foldably to each other. The recording module has a frame unit mounted on the cover member, a data storage unit mounted on the frame unit for storing audio information, and audio recording and playback units mounted on the frame unit and coupled to the data storage unit. The audio recording unit is operable so as to record the audio information in the data storage unit. The audio playback unit is operable so as to audibly reproduce the audio information in the data storage unit. The notepad is retained in the cover member and is disposed between the front and back cover parts.

### BRIEF DESCRIPTION OF THE DRAWINGS

Other features and advantages of the present invention will become apparent in the following detailed description of the preferred embodiments with reference to the accompanying drawings, of which:

FIG. 1 is an assembled perspective view of the first preferred embodiment of a notebook according to the present invention;

FIG. 2 is an exploded perspective view of the first preferred embodiment;

FIG. 3 is a partly sectional view of the first preferred embodiment taken along line 3-3 of FIG. 1, illustrating assembly of a frame unit of a recording module to a front cover part;

FIG. 4 is a block diagram of the recording module of the first preferred embodiment;

FIG. 5 is an exploded perspective view of the second preferred embodiment of a notebook according to the present invention;

FIG. 6 is a partly sectional view of the second preferred embodiment, illustrating assembly of the frame unit of the recording module to the front cover part; and

FIG. 7 is the same view as FIG. 6, but illustrating the third preferred embodiment of a notebook according to the present invention.

### DETAILED DESCRIPTION OF THE PREFERRED EMBODIMENTS

Before the present invention is described in greater detail, it should be noted that like elements are denoted by the same reference numerals throughout the disclosure.

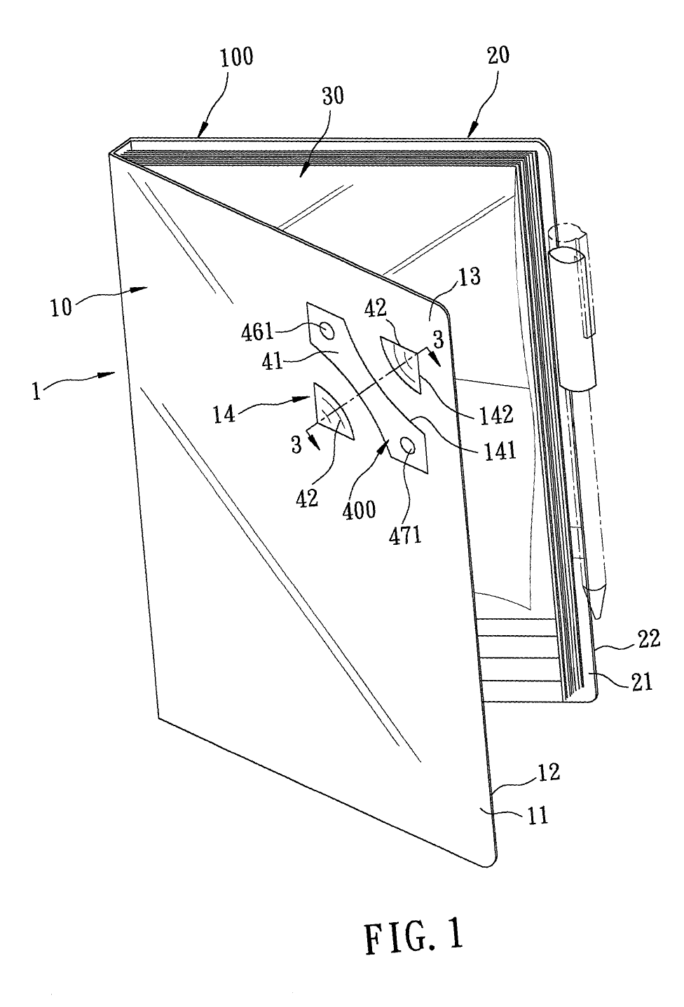

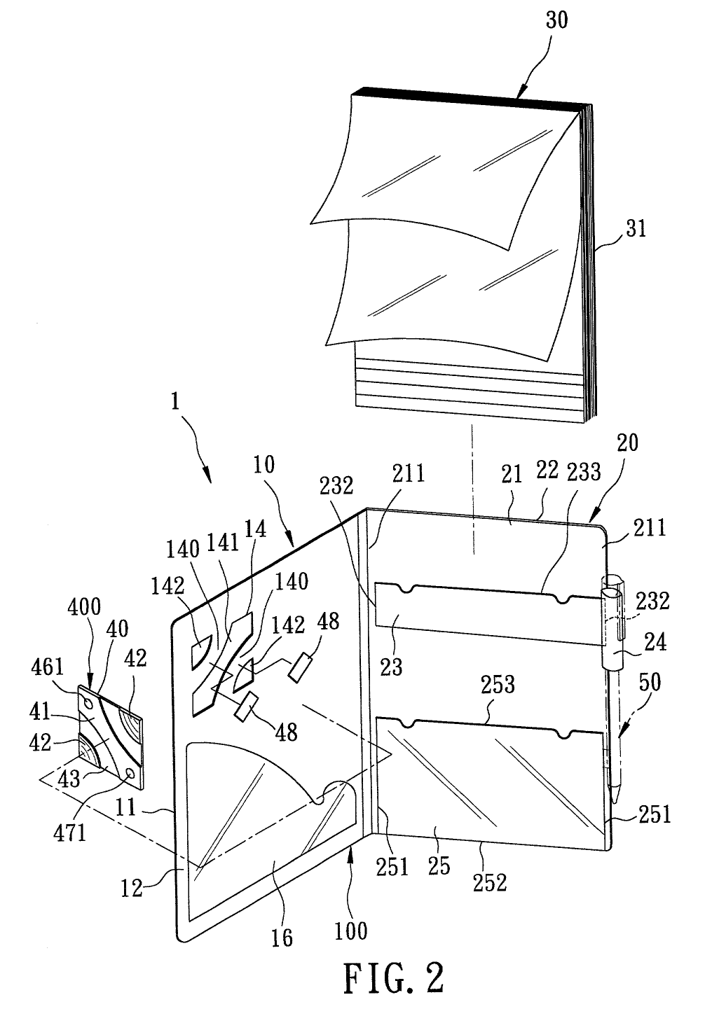

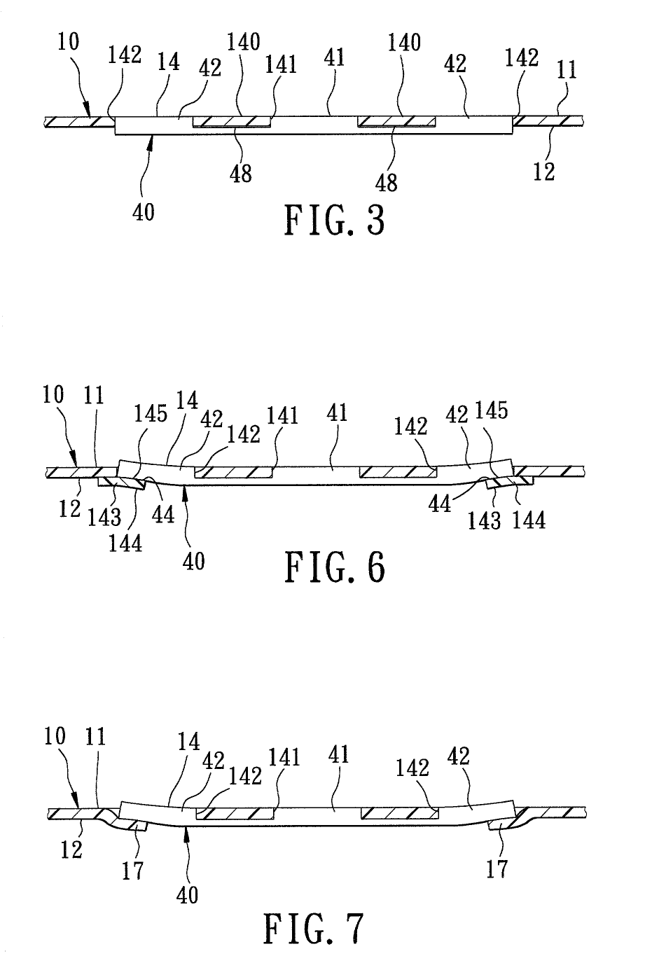

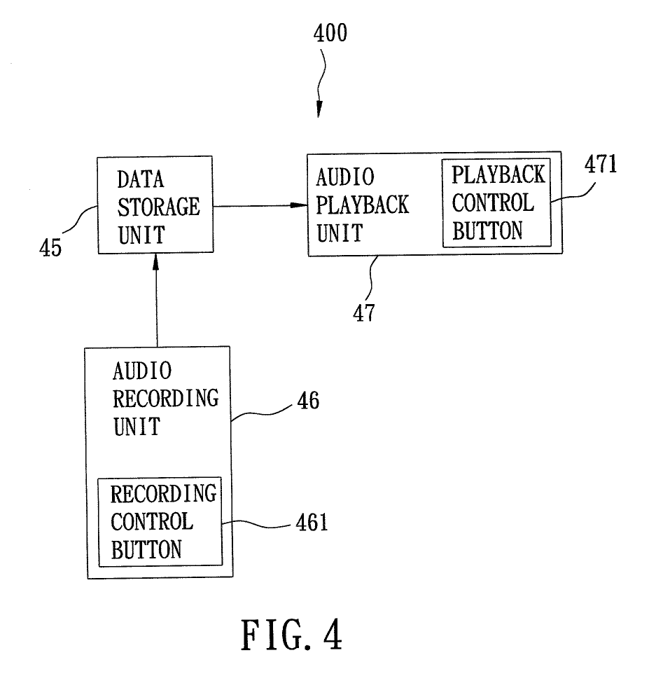

Referring to FIGS. 1 to 3, in combination with FIG. 4, the preferred embodiment of a notebook 1 according to the present invention is shown to include a foldable cover member 100, a recording module 400, and a notepad 30.

The cover member 100 includes front and back cover parts 10, 20 connected foldably to each other. The front cover part 10 has outer and inner surfaces 11, 12 opposite to each other in a first direction. The back cover part 20 has outer and inner surfaces 22, 21 opposite to each other in the first direction. One of the front and back cover parts 10, 20 is formed with a window 14. The window 14 is rectangular in shape and has a retaining strip 140 that extends between two adjoining window edges thereof. In this embodiment, the window 14 is formed in the front cover part 10 near a corner 13. The window 14 extends from the inner surface 12 to the outer surface 11 in the first direction, and has two retaining strips 140, each of which extends between two adjoining window edges thereof to thereby define two opposing corner window portions 142 and a diagonally extending middle window portion 141 between the corner window portions 142. The inner surface 21 of the back cover part 20 has left and right lateral edges 211 opposite to each other in a second direction that is transverse to the first direction.

The recording module 400 has a frame unit 40 mounted on the front cover part 10 of the cover member 100 at the window 14, a data storage unit 45 mounted on the frame unit 40 for storing audio information, and audio recording and playback units 46, 47 mounted on the frame unit 40 and coupled to the data storage unit 45. The audio recording unit 46 has a recording control button 461 operable so as to record the audio information in the data storage unit 45. The audio playback unit 47 has a playback control button 471 operable so as to audibly reproduce the audio information in the data storage unit 45. The frame unit 40 is rectangular in shape, and has front and rear side surfaces opposite to each other. The front side surface is formed with a retaining recess 43 that extends between two adjoining side edges thereof. In this embodiment, the frame unit 40 is formed with two retaining recesses 43 for receiving the retaining strips 140 of the window 14. Each of the retaining strips 140 is attached adhesively to the front side surface of the frame unit 40 in a respective one of the retaining recesses 43 by using double-sided adhesive tapes 48. The front side surface of the frameunit 40 further has a raised portion 41 that is offset from and that extends between the recessed portions 43 and between two diagonally opposite corners thereof, and that is provided with the recording and playback control buttons 461, 471, and two raised corner portions that are respectively disposed at two other diagonally opposite corners thereof offset from the recessed portions 43 and that are respectively provided with sound ports 42. As such, after the front side surface of the frame unit 40 is adhesively attached to the inner surface 12 of the front cover part 10 at the window 14, the recording and playback control buttons 461, 471, and the two sound ports 42 can be exposed from the outer surface 11 of the front cover member 10 at the middle window portion 141 and the two corner window portions 142, respectively.

The notepad 30 is retained in the cover member 100 and is disposed between the front and back cover parts 10, 20. The notepad 30 has a backing sheet 31, and the inner surface 21 of the back cover part 20 is provided with a retaining strap 23 for retaining removably the backing sheet 31 of the notepad 30. The retaining strap 23 extends in the second direction, and has opposite ends 232 connected to the left and right lateral edges 211, respectively, using known high frequency welding techniques. The retaining strap 23 and the inner surface 21 of the back cover part 20 cooperatively define a retaining space 233 that permits the backing sheet 31 to extend therethrough. A pocket 25 with a top opening 253 is additionally formed below the retaining strap 23 to receive and position the backing sheet 31 of the notepad 30 that extends through the retaining space 233 by securing two opposite ends 251 and a bottom end 252 of a sheet 25 to the left and right lateral edges 211 and a bottom edge of the inner surface 21 of the back cover part 20 using known high frequency welding techniques. In addition, the inner surface 12 of the front cover part 10 is provided with a fan-shaped pocket 16 near a bottom edge thereof in a securing manner similar to that employed for the pocket 25 to hold documents.

The notebook 1 further includes a tubular holding member 24 which is connected to the inner surface 21 of the back cover part 20 proximate to the retaining strap 23 using known high frequency welding techniques and which is adapted to retain a writing instrument 50 thereon.

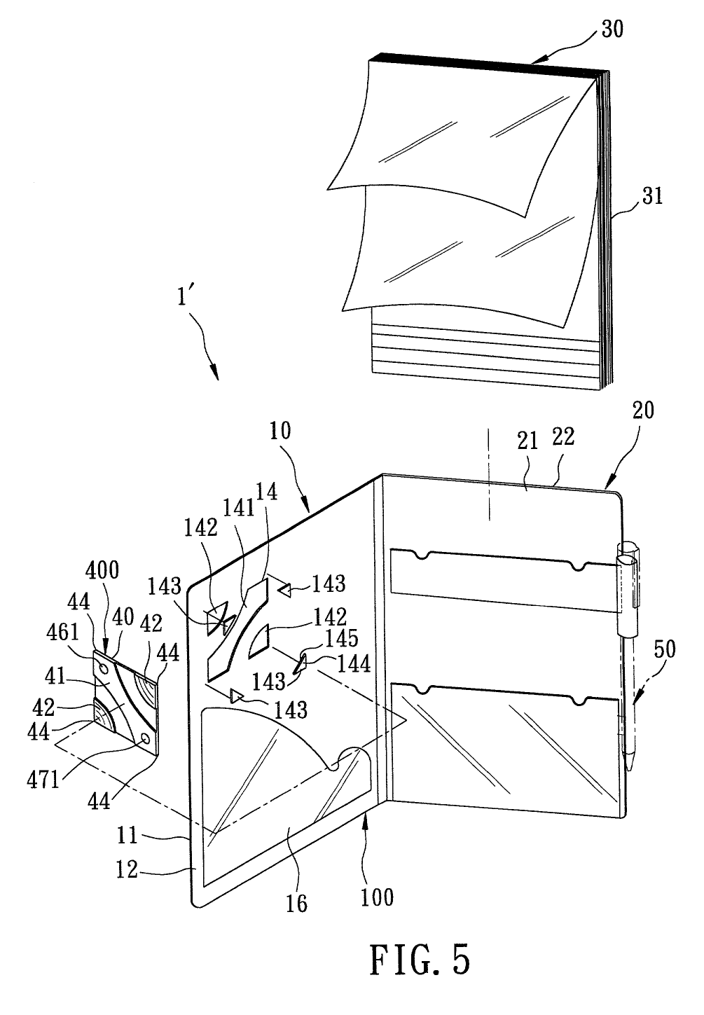

FIGS. 5 and 6 illustrate the second preferred embodiment of a notebook 1′ according to the present invention This embodiment is substantially the same as the previous embodiment in construction, the main difference residing in that the notebook 1′ further includes a plurality of corner strips 143, each having opposite inner and outer sides 144, 145. The corner strips 143 are connected to the inner surface 12 of the front cover part 10 at corners of the window 14 such that when four corner portions 44 of the frame unit 40 are flexibly bent and extended through the corners of the window 14 so as to be exposed from the corner window portions 142 and the middle window portion 141, the outer side 145 of each of the corner strips 143 abuts against the rear side surface of the frame unit 40 at the corner portions 44 thereof. As such, the frame unit 40 can be securely positioned at the window 14, and can be removably assembled to or separated from the cover member 100 with ease.

Referring to FIG. 7, the third preferred embodiment of a notebook according to the present invention is shown to differ from the second preferred embodiment in that the inner surface 12 of the front cover part 10 extends integrally and radially inward at the corners of the window 14 to form corner extensions 17 that function in a manner similar to the corner strips 143 in the second preferred embodiment.

By virtue of the construction of the present invention, the user can record reminder notes to remind him or her of appointments, important events, etc. When the notebook is given as a gift, the user can record a voice message conveying his or her feelings to the recipient of the gift. Besides, the recording module can be easily assembled to and detached from the cover member of the notebook.

While the present invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

I claim:

1. A notebook comprising:
a foldable cover member including front and back cover parts connected foldably to each other;
a recording module having a frame unit mounted on said cover member, a data storage unit mounted on said frame unit for storing audio information, and audio recording and playback units mounted on said frame unit and coupled to said data storage unit, said audio recording unit being operable so as to record the audio information in said data storage unit, said audio playback unit being operable so as to audibly reproduce the audio information in said data storage unit; and
a notepad retained in said cover member and disposed between said front and back cover parts.

2. The notebook according to claim 1, wherein:
each of said front and back cover parts has outer and inner surfaces opposite to each other in a first direction;
one of said front and back cover parts being formed with a window extending from said inner surface to said outer surface in the first direction;
said frame unit of said recording module being mounted on said one of said front and back cover parts at said window.

3. The notebook according to claim 2, wherein:
each of said frame unit and said window is rectangular in shape, said frame unit having a front side surface formed with a retaining recess that extends between two side edges thereof, said window having a retaining strip that extends between two window edges thereof and that is received in said retaining recess.

4. The notebook according to claim 3, further comprising an adhesive tape for attaching adhesively said retaining strip to said front side surface of said frame unit in said retaining recess.

5. The notebook according to claim 3, wherein said frame unit further has a rear side surface opposite to said front side surface, said notebook further comprising a plurality of corner strips disposed on said inner surface of said one of said front and back cover parts at corners of said window to abut respectively against corner portions of said rear side surface of said frame unit.

6. The notebook according to claim 5, wherein said corner strips are integrally formed with said one of said front and back cover parts.

7. The notebook according to claim 3, wherein said front side surface of said frame unit further has a raised portion offset from said recessed portion and provided with a sound port, said audio recording unit having a recording control button disposed on said raised portion and operable so as to enable said audio recording unit to record the audio information in said data storage unit, said audio playback unit having a playback control button disposed on said raised portion and operable so as to enable said audio playback unit to audibly reproduce the audio information in said data storage unit.

8. The notebook according to claim 2, wherein said notepad has a backing sheet, and said inner surface of the other one of said front and back cover parts is provided with a retaining strap for retaining removably said backing sheet of said notepad.

9. The notebook according to claim 8, wherein the other one of said front and back cover parts further has left and right lateral edges opposite to each other in a second direction that is transverse to the first direction, said retaining strap extending in the second direction and having opposite ends connected to said left and right lateral edges, respectively, said retaining strap and said inner surface of the other one of said front and back cover parts defining a retaining space that permits said backing sheet to extend therethrough.

10. The notebook according to claim 1, further comprising a tubular holding member connected to said cover member and adapted to retain a writing instrument thereon.
